(19) United States
(12) Patent Application Publication
(10) Pub. No.: US 2006/0061565 A1
(43) Pub. Date: Mar. 23, 2006

(54) Multiple-silhouette sculpture using stacked polygons

(76) Inventor: Michael Messner, Rockville, MD (US)

Correspondence Address: BIOTECHPATENT. NET, LLC, No. 221, 5284 RANDOLPH ROAD, ROCKVILLE, MD, 20852, US

(21) Appl. No.: 10/943,948

(22) Filed: Sep. 20, 2004

(51) Int. Cl. G06T 1/00; G06F 17/00

(52) U.S. Cl. 345/418

(57) ABSTRACT

This invention provides a method for sculpting of images having as many as 2*N silhouettes using stacked polygons with N vertices, where N is an integer greater than 0.

This application is directed to the Invention Disclosure Document, filed on Jan. 29, 2003.

### FIELD OF THE INVENTION

This present invention relates to 3-D images generated by a spinning sculpture that would display a different silhouette for varied degrees of rotation.

### BACKGROUND OF THE INVENTION

While in elementary school, each of us has the experience of drawing the silhouette of a famous American. Presidents Washington, Jefferson, and Lincoln are often the subjects due to their importance, but also their distinctive facial features. Other popular subjects include Susan B. Anthony, Rev. Martin Luther King, and John F. Kennedy. With a large scroll saw, one could take a large cube of wood and cut the silhouette in the wood. FIG. 1 shows the result of cutting a right-facing George Washington in such a cube. After cutting three other silhouettes in the other vertical faces of the cube, one would have a sculpture whose four rather jagged edges/corners would describe the four silhouettes. Every horizontal slice through the sculpture would be a rectangle. So, the sculpture consists of four sets of vertices (the corners of the rectangles) and four sets of lines (the edges of the rectangles).

The invention described here is a process for vastly improving on the above approach. Up to eight silhouettes can be provided by a figure having only four sets of vertices and four sets of lines. Similarly, a sculpture of up to six silhouettes can be built using three sets of vertices and three sets of lines. All six historical figures mentioned above could be displayed in a single sculpture for which every horizontal slice is a triangle! Indeed, the object can be constructed by carefully stacking a large number of precisely cut triangles.

It is to these ends, that various aspects of the present invention are directed.

### SUMMARY OF THE INVENTION

The invention provides a process for sculpting as many as 2*N silhouettes using stacked polygons with N vertices, where N is an integer greater than 0. The simplest such sculpture would be for N=1, in which case, the “polygons” are points and could be displayed as small objects stacked to form a snaking curve. The objects would only be large enough to permit their joining so the whole think holds together. The sculpture for N=2 would be polygons of dimension one (line segments) displayed by a stack of flat bars whose endpoints would define the silhouettes. The simplest interesting polygon structure is that for N=3 (triangles), producing as many as six silhouettes.

### BRIEF DESCRIPTION OF THE DRAWINGS

FIG. 1 shows Right-facing George Washington, cut into a rectangular solid.

FIG. 2 shows a horizontal slice through the vertical sculpture as triangle αβγ.

FIG. 3 shows six mathematical functions of Six Silhouettes.

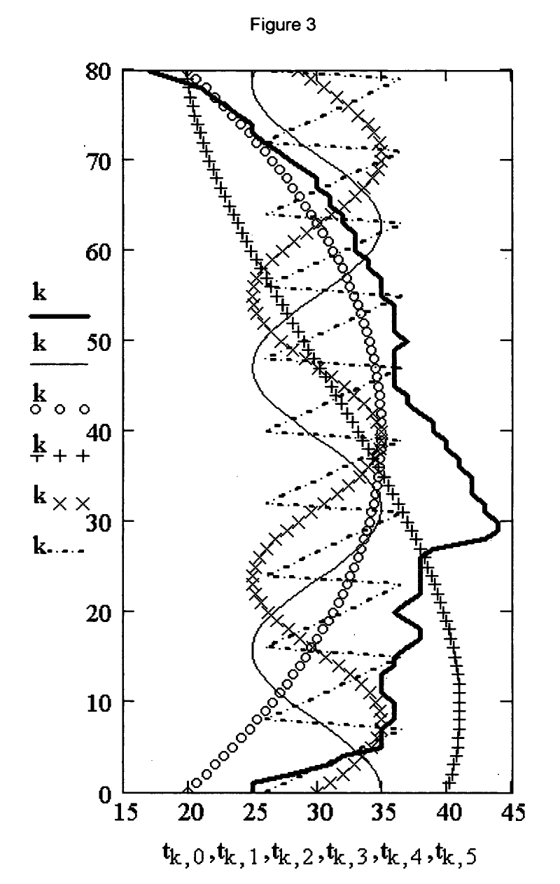

FIG. 4 shows a Digital drawing of the stacked triangles.

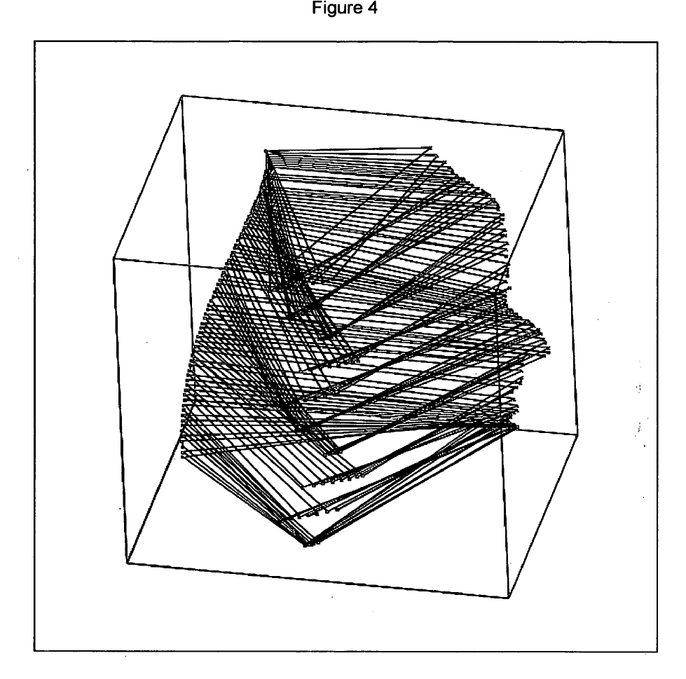

FIG. 5 shows a Photograph of the finished sculpture.

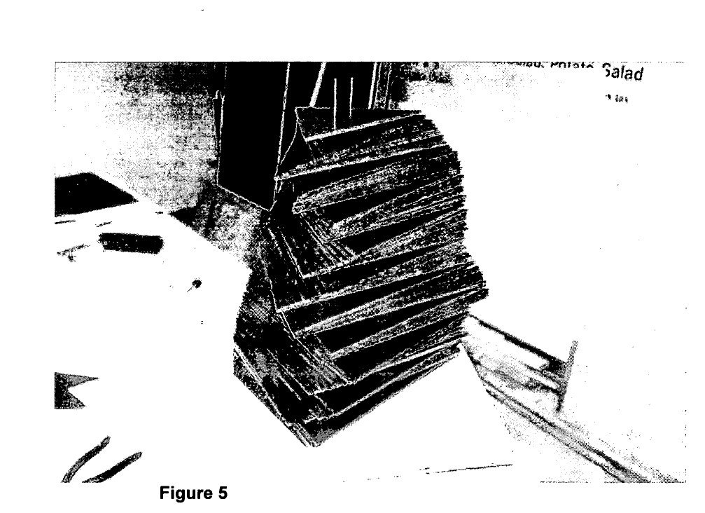

FIG. 6 shows an alternate stacked triangle.

FIG. 7 shows a 5 silhouette design; wherein one point is randomly located along a line segment.

FIG. 8 shows a Photograph of a sculpture using alternating Plexiglas triangles.

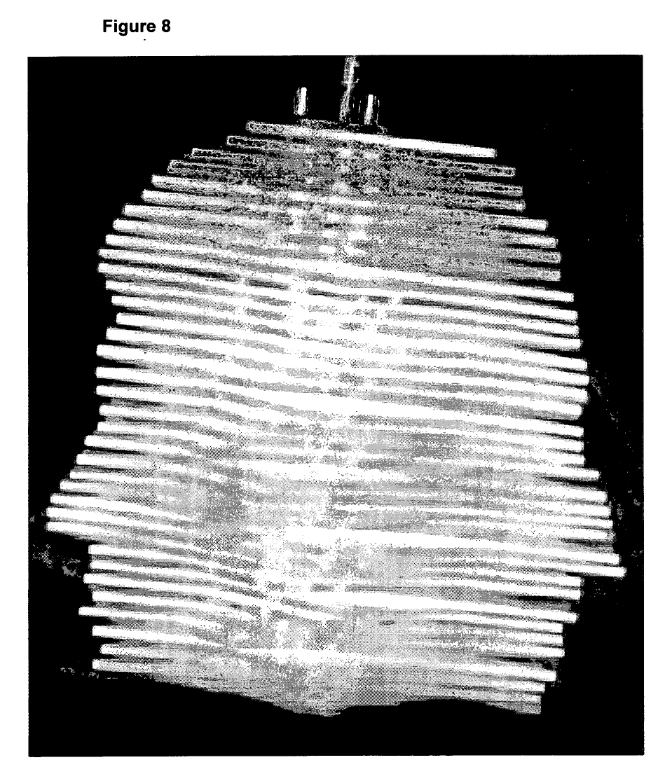

### DETAILED DESCRIPTION

In the present invention, a spinning sculpture would display a different silhouette for selected degrees of rotation. A 3-D object is imaged from various imaging points. The 3-D surface is, itself, approximated using polygons. The polygons thus provide a 3-D surface representation of the surface of the object. The stacked polygonals represent the surface silhouette.

The invention is drawn to a process for sculpting as many as 2*N silhouettes using stacked polygons with N vertices, where N is an integer greater than 0. The simplest such sculpture would be for N=1, in which case, the “polygons” are points with dimension zero and could be displayed as small objects stacked to form a snaking curve. The objects would only be large enough to permit their joining so the whole think holds together. The sculpture for N=2 would be polygons of dimension one (line segments) displayed by a stack of flat bars whose endpoints would define the silhouettes. The simplest interesting polygon structure is that for N=3 (triangles), producing as many as six silhouettes. Stacked polygons can be used to produce sculptures comprised, but not limited to: families and other groups of individuals, ornamental statues, and the design of many-storied buildings to give the building different appearances from different angles. Additionally, the use of single sets of vertices in two (rather than one) silhouettes is used. As the sculpture rotates, the sets of points are seen to “morph” from one silhouette into another.

There are numerous alternatives to the simple stacked triangles described above. Stacked quadrilaterals can portray up to eight silhouettes. Stacked pentagons can portray up to ten. If the images displayed are human silhouettes, the number portrayed is limited by the differences between silhouettes. With too many silhouettes, one person's large nose could obscure his neighbor's images.

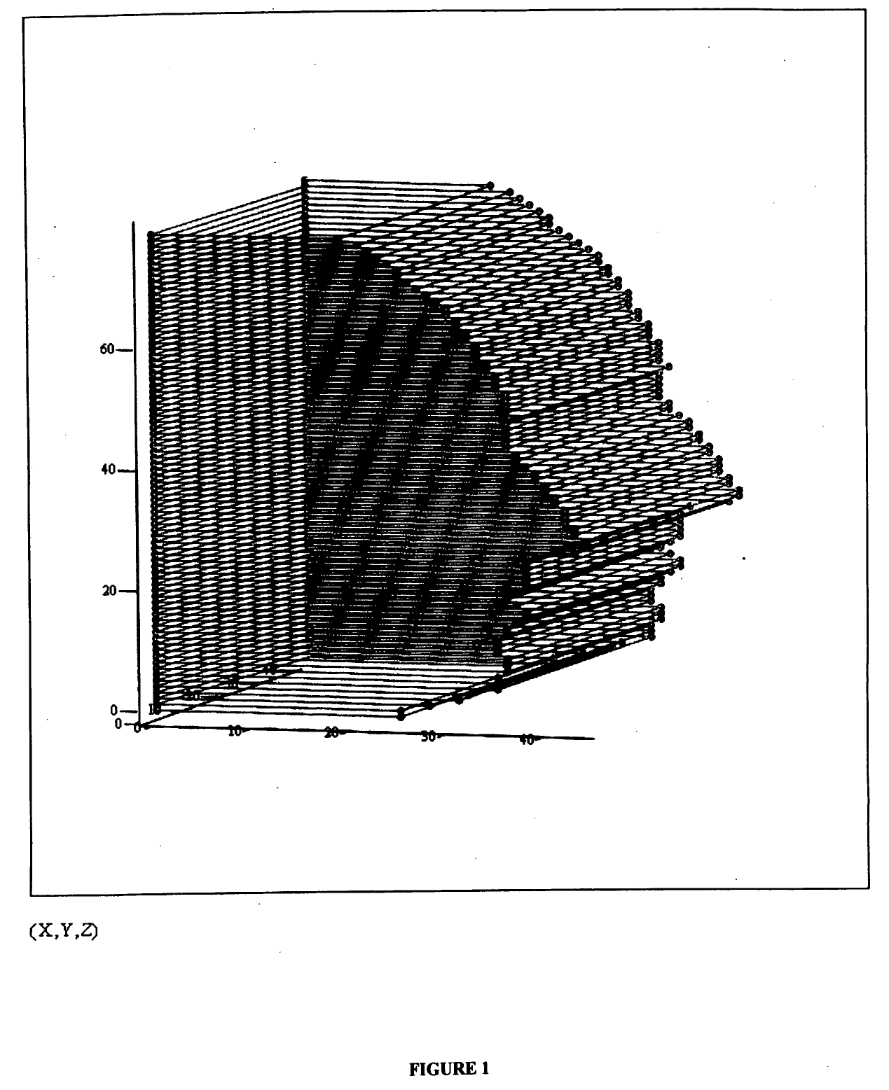

The basic idea is using N stacked polygons to portray up to 2*N silhouettes. The polygons are “Aligned” in the sense, from the basic drawing (such as FIG. 1), vertices of the polygon are always from the same basic orientation (e.g., vertex α will always be between points A and B while no vertex is ever between points B and C).

### Preferred Embodiment

The following formulation teaches one embodiment of this invention. Those skilled in trigonometry can modify the methods disclosed in numerous ways to achieve equivalent performance.

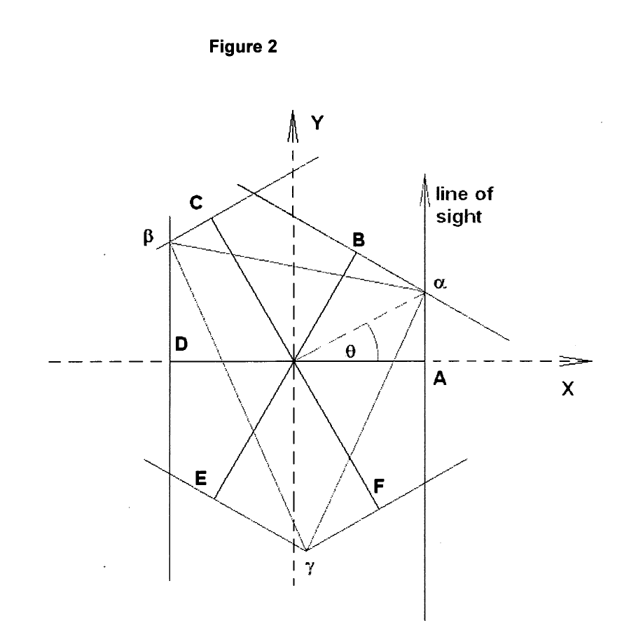

FIG. 2 below shows a horizontal slice through the vertical sculpture as triangle αβγ. In the figure, points A, B, C, D, E, and F are distanced from the center such that the line from the center through the point is normal to the line of sight for a silhouette and the point is a point of the silhouette. While stacked hexagons with vertices A, B, C, D, E, and F would describe the six silhouettes, notice that the three points labeled α, β, and γ can serve the same purpose. From the line of sight shown in the figure, point α lines up with point A, but if viewed from a different angle (60 degrees), aligns with point B. Similarly, point β performs appears in other lines of sight for points C and D, while point γ appears in lines of sight for E and F.
Let k=height=polygon number=0.80
Let a=silhouette number=0.5
t_{k,a}=distance from center to silhouette a's face at height k (normal to line-of-sight)
   θ_{k,a}=a tan (⅓*(−t_{k,a}+2t_{k,if(a=5,0,a+1)}* sqrt (3)/t_{k,a})
θ_{k,a} is the angle between the a^{th} face and the sculpted point, which is between the a^{th} face and face a+1 (or face 0, in the case of a=5).
δ_{k,a}=t_{k,a}/cos (θ_{k,a})=distance from center to vertex a.
η_{k,a}=θ_{k,a}+a*π/3=angle from x-axis to vertex a.
The (x,y) coordinates of vertex a are
   x_{k,a}=δ_{k,a}*cos (η_{k,a}) and x_{k,a}=δ_{k,a}*sin (η_{k,a})

### EXAMPLE

One silhouette is from a portrait of George Washington by James Sharples (circa 1796). Other silhouettes are simple mathematical functions (a sine curve, a cosine curve, a quadratic function, a cubic function, and a zig-zag function):
t_{k,0}=Digitized silhouette of George Washington, taken from National Portrait Gallery webpage image as shown in FIG. 1, Coordinates for George Washington's Silhouette.
   t_{k,1}=30+5* cos (k/5) (a cosine curve)
   t_{k,2}=20+0.75*k−0.009375*k² (a quadratic function)
   t_{k,3}=40+0.229*k−0.014*k²+0.0001*k³ (a cubic function)
   t_{k,4}=30+5* sin (k/5) (a sine curve)
   t_{k,5}=20+mod (k,8)*15 ( a zig-zag function)

Furthermore, the silhouettes can be displayed in a stack of alternating triangles comprising, but not limited to:

Random triangles (only 3 silhouettes)

Simple stacked hexagons, where coordinates are:
X_{k,a}=t_{k,a}*cos (π*a/3) and X_{k,a}=t_{k,a}*sin (π*a/3)

Hexagons using six vertices of the triangles.

Points randomly assigned from the six sides of the hexagons:
XX_{k,a}=Pₖ*X_{k,a}+(I−Pₖ)*Xₖ, if {a=5,0,a+1)
YY_{k,a}=Pₖ*X_{k,a}+(I−Pₖ)*Xₖ, if {a=5,0,a+1)

P˜unif (O,I)

Stacked rods to make four silhouettes. Rods can be curved to facilitate stacking.

Stacked “points” to portray two silhouettes.

Alternating Stacked Polygons

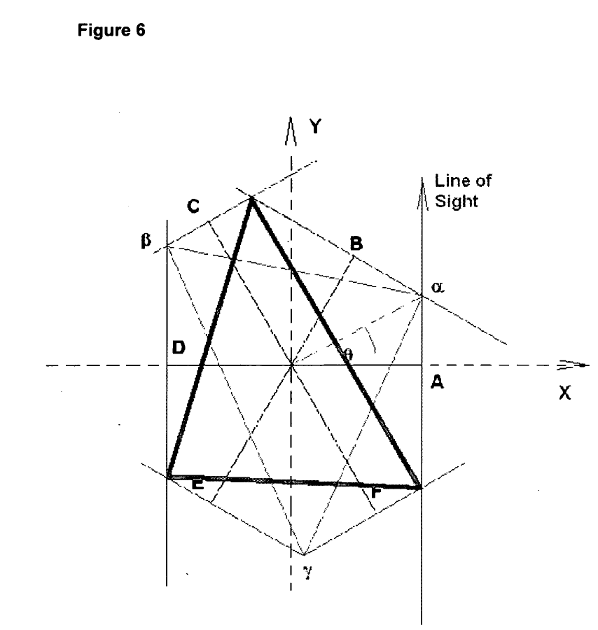

In FIG. 2, the triangle drawn is one of two that are possible for describing the six silhouettes. An alternative is to stack alternating triangles. In this design, two triangles given by points α, β, and γ, will have between them one given by points between B and C, between D and E, and between F and A. This alternate alignment is shown in FIG. 6.

Polygons with One or More “Random” Vertices

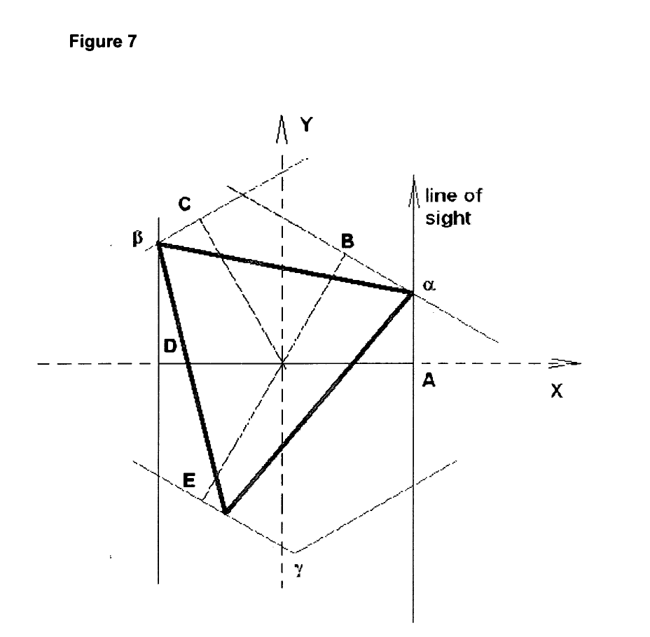

When fewer than 2*N silhouettes are to be portrayed by polygons with N sides, there is additional flexibility in selecting vertices. FIG. 7 shows that, when silhouette F is no longer required, rather than point γ (which was used in both silhouettes E and F), any point along the line segment that includes E and terminates at γ can be used to portray silhouette E. The triangle of FIG. 7 uses a point near the midpoint of the available line segment.

Polygon Edges (Rather than Polygons)

When polygon-shaped materials are used, the resulting structure is solid, with no voids in the interior. An alternative allows is to use only the polygon edges. Edges can be constructed of rods or bars fastened at their ends. Stacking these produces a sculpture with interior voids.

What is claimed is:

1. A method for sculpting as many as 2*N silhouettes using stacked polygons with anywhere from N to 2*N vertices, where N is an integer greater than 1.

2. The method of claim 1, wherein the vertices of the polygon are always from the same basic orientation.

3. The method of claim 1, wherein the polygons are stacked in an alternating pattern; wherein two polygons given by points α, β, and γ, will have between them one given by points between B and C, between D and E, and between F and A as shown in FIG. 6.

4. The method of claim 1, wherein said polygons have one or more random vertices, as shown in FIG. 7.

5. The method of claim 1, wherein polygon edges, optionally constructed of rods or bars fastened at their ends, are stacked producing a sculpture with interior voids.
